(19) United States
(12) Patent Application Publication
(10) Pub. No.: US 2009/0327657 A1
(43) Pub. Date: Dec. 31, 2009

(54) GENERATING AND PERFORMING DEPENDENCY CONTROLLED FLOW COMPRISING MULTIPLE MICRO-OPERATIONS (uops)

(76) Inventors: Zeev Sperber, Zichron Yaakov (IL); Sagi Lahav, Kiryat Bialik (IL); Guy Patkin, Beit-Yanay (IL); Simon Rubanovich, Haifa (IL); Amit Gradstein, Binyamina (IL); Yuval Bustan, Moshav Mismeret (IL)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/146,390

(22) Filed: Jun. 25, 2008

(51) Int. Cl. G06F 9/22

(52) U.S. Cl. 712/205; 712/216; 712/E09.005

(57) ABSTRACT

A processor to perform an out-of-order (OOO) processing in which a reservation station (RS) may generate and process a dependency controlled flow comprising multiple micro-operations (uops) with specific clock based dispatch scheme. The RS may either combine two or more uops into a single RS entry or make a direct connection between two or more RS entries. The RS may allow more than two source values to be associated with a single RS by combining sources from the two or more uops. One or more execution units may be provisioned to perform the function defined by the uops. The execution units may receive more than two sources at a given time point and produce two or more results on different ports.

### BACKGROUND

A computer system may comprise a processor, which may implement an out-of-order (OOO) processing. The processor may generate one or more micro-instructions (uops) from an instruction and map each uop into an entry (RS entry), which may be stored in the reservation station (RS). The processor may also map a flow of uops to several RS entries that communicate between each other using source dependencies.

While performing an out-of-order processing, the processor may dispatch each RS entry in the reservation station after the RS entry is ready to be dispatched. The RS entry may be ready for dispatch if the two sources associated with that RS entry are ready. Also, the execution of a second uop may be dependant on the completion of a first uop and a connection needs to be established between the first and the second uop for the instruction to be executed.

However, establishing a connection between the uops using source dependency may require that the uops be allocated in the same allocation window and such a limit may reduce the allocation bandwidth. Also, some out-of-order processing may require more than two sources to be associated with the RS entry.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a computer system 100, which includes a technique for generating and processing dependency controlled flow comprising multiple uops according to one embodiment.

FIG. 2(a) illustrates a processor in which dependency controlled flow comprising multiple uops is generated and processed according to one embodiment.

FIG. 2(b) illustrates a reservation station in which two uops are fused to generate a single RS entry according to one embodiment.

FIG. 2(c) illustrates an execution unit performing the operations provided by the reservation station according to one embodiment.

FIG. 3 is a flow diagram illustrating a 64×64 bit multiplication handled by the processor according to one embodiment.

FIG. 4 is a timing diagram illustrating a 64×64 bit multiplication performed by the processor according to other embodiment.

FIG. 5 illustrates an execution unit, which performs execution of uops provided by the reservation station in accordance with at least one embodiment of the invention.

### DETAILED DESCRIPTION

The following description describes embodiments of a technique to generate and process dependency controlled flow comprising multiple uops in a computer system or computer system component such as a microprocessor. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, and digital signals). Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

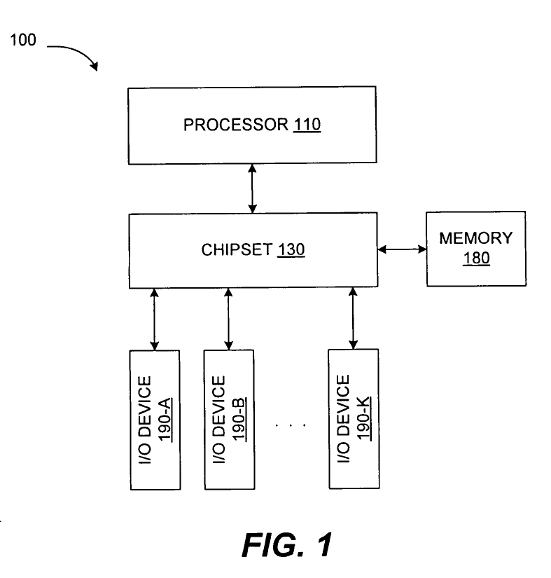

A computing device 100, which may support techniques to handle multiple uops dependency controlled flow in accordance with one embodiment, is illustrated in FIG. 1. In one embodiment, the computing device 100 may comprise a processor 110, a chipset 130, a memory 180, and I/O devices 190-A to 190-K.

The chipset 130 may comprise one or more integrated circuits or chips that operatively couple the processor 110, the memory 180, and the I/O devices 190. In one embodiment, the chipset 130 may comprise controller hubs such as a memory controller hub and an I/O controller hub to, respectively, couple with the memory 180 and the I/O devices 190. The chipset 130 may receive transactions generated by the I/O devices 190 on links such as the PCI Express links and may forward the transactions to the memory 180 or the processor 110. Also, the chipset 130 may generate and transmit transactions to the memory 180 and the I/O devices 190 on behalf of the processor 110.

The memory 180 may store data and/or software instructions and may comprise one or more different types of memory devices such as, for example, DRAM (Dynamic Random Access Memory) devices, SDRAM (Synchronous DRAM) devices, DDR (Double Data Rate) SDRAM devices, or other volatile and/or non-volatile memory devices used in a system such as the computing system 100. In one embodiment, the memory 180 may store software instructions such as MUL and FMA and the associated data portions.

The processor 110 may manage various resources and processes within the processing system 100 and may execute software instructions as well. The processor 110 may interface with the chipset 130 to transfer data to the memory 180 and the I/O devices 190. In one embodiment, the processor 110 may retrieve instructions and data from the memory 180, process the data using the instructions, and write-back the results to the memory 180.

In one embodiment, the processor 110 may support techniques to generate and process dependency controlled flow comprising multiple uops. In one embodiment, such a technique may allow the processor 110 to map a combination of multiple uops into a single RS entry or support direct connection between two or more RS entries. In one embodiment, combining multiple uops into a single RS entry may allow more than two sources to be associated with a single RS entry. In one embodiment, the direct connection between two or more RS entries may allow the RS entries to be performed without using source dependencies or with an override of the normal selection of a ready uop for dispatch, wherein the dispatch criteria may be based on source dependencies and sources becoming ready.

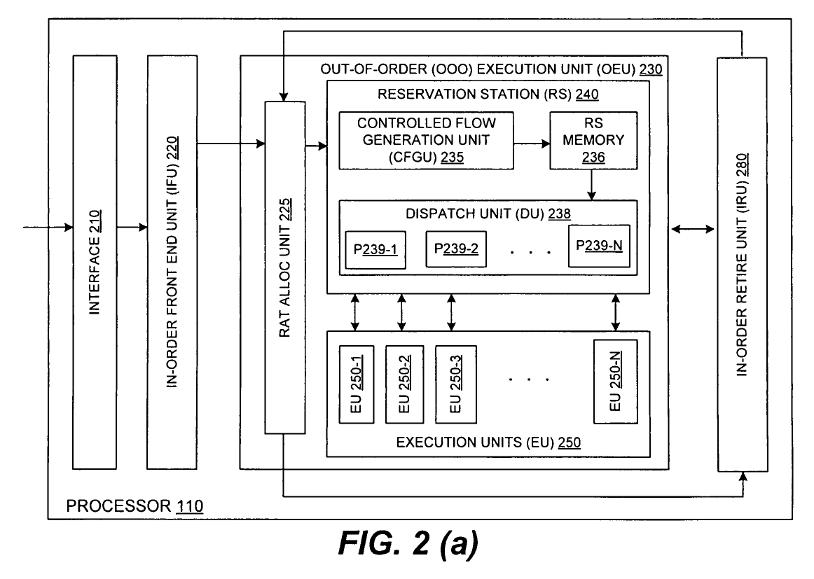

A processor 110 in which a technique of generate and process dependency controlled flow comprising multiple uops in accordance to one embodiment is illustrated in FIG. 2(a). In one embodiment, the processor 110 may comprise a processor interface 210, an in-order front end unit (IFU) 220, an out-of-order execution unit (OEU) 250, and an in-order retire unit (IRU) 280.

The processor interface 210 may transfer data units between the chipset 130 and the memory 180 and the processor 110. In one embodiment, the processor interface 210 may provide electrical, physical, and protocol interfaces between the processor 110 and the chipset 130 and the memory 180.

In one embodiment, the in-order front-end unit (IFU) 220 may fetch and decode instructions into micro-operations (“uops”) before transferring the uops to the OEU 230. In one embodiment, the IFU 220 may comprise an instruction fetch unit to pre-fetch and pre-code the instructions. In one embodiment, the IFU 220 may also comprise an instruction decoder, which may generate one or more micro-operations (uops) from an instruction fetched by the instruction fetch unit.

In one embodiment, the in-order retire unit (IRU) 280 may comprise a re-order buffer. After the execution of uops in the execution unit 250, the executed uops return to the re-order buffer and the re-order buffer retires the uops based on the original program order.

In one embodiment, the OEU 230 may receive the uops from the IFU 220 and may generate a dependency controlled flow comprising multiple uops such as uop-1, uop-2, uop-3, uop-4. In one embodiment, the OEU 230 may further perform the operations specified by the uops. In one embodiment, dependency controlled flow comprising multiple uops may refer to a flow in which some uops are coupled together based on dependency of the uops. For example, the OEU 230 may generate a dependency controlled flow, wherein the uop-4 is scheduled to be dispatched after a specific time elapses after dispatching the uop-1. In one embodiment, the uop-4 may be designated as a second uop of the dependency controlled flow such that uop-4 may be dispatched after the uop-1 is dispatched even if uop-2 is older and ready for dispatch.

In one embodiment, the timing of dispatch of each of the present uops coupled by dependency has a strict and constant relationship to a previous uop dispatched. In one embodiment, the number of uops in the dependency controlled flow may be bound by the number of uops allocated per clock as the complete dependency may be required in order to perform the dependency check. In one embodiment, all the uops in the dependency flow may be at the same allocation window.

In one embodiment, the OEU 230 may comprise a RAT ALLOC unit 225, a reservation station RS 240 and an array of execution units 250. In one embodiment, the register alias table (RAT) may allocate a destination register for each of the uop. In one embodiment, the RAT ALLOC 225 may rename the sources and allocate the destination of uops. In one embodiment, the RAT ALLOC unit 225 may also determine the uop dependencies and allocate the uops to be scheduled into the reservation station RS 240. In one embodiment, the reservation station RS 240 may comprise a controlled flow generation unit (CFGU) 235 and a dispatch unit 238. In one embodiment, the controlled flow generation unit CFGU 235 may receive the uops from the RAT ALLOC unit 225 and generate a dependency controlled flow of multiple uops.

While generating a dependency controlled flow, in one embodiment, the CFGU 235 may combine two or more uops and store the combined uops as a single RS entry. In one embodiment, the CFGU 235 while combining two or more uops into a single RS entry may allow the sources associated with the two or more uops to be coupled with the single RS entry. In one embodiment, such an approach may overcome the restriction that each uop may rename two sources per uop at the allocation stage and allocate operations that may require three sources such as Fused Multiply and ADD (FMA operation).

In one embodiment, the CFGU 235 may receive a uop-221 (first uop) associated with a first source value Src1 and a uop-222 (second uop) associated with a second source value Src2 as shown in FIG. 2(b). The CFGU 235 may combine the uop-221 and uop-222 into a single RS entry 224. In one embodiment, the CFGU 235 may encode the uop-221 and uop-222 to generate a single RS entry 224 and couple the first and the second source values Src1 and Src2 with the single RS entry 224 as depicted in FIG. 2(b).

In one embodiment, the CFGU 235 may combine uop-221 and uop-222 using uops combining techniques. In one embodiment, the CFGU 235 may generate a combined uop by encoding the uops 221 and 222. In one embodiment, the combined uop may be generated using complementary metal-oxide semiconductor (CMOS) circuitry, or software, or a combination thereof. The RS entry 224 so formed may be stored in a RS memory 236, which may comprise a cache memory, for example. Such an approach may allow more than two sources to be associated with a uop.

In other embodiment, the CFGU 235 may create a connection between two or more RS entries stored in the RS memory 236. In one embodiment, the CFGU 235 may detect and mark the first and the second uop and as a result, the RS 240 may provide connection between the RS entries by asserting a line after a first uop is dispatched. In one embodiment, the assertion of the line may override the conventional picking mechanism used for selecting the next uop. In one embodiment, while the line is set, the CFGU 235 may select only a second uop, which is ready, and which is of the type associated with the first uop. As the first uop broadcasts its validity, the second uop may be the only ready uop of the type that the RS 240 may pick-up.

For example, if the selection mechanism is based on first-in-first-out (FIFO) order, the other older uops, which may be ready may not be selected due to assertion of the line. However, the only ready uop of the specific type may be selected. In one embodiment, the uops picked based on the connection may ensure proper timing for the second uop to be picked up for dispatching. In one embodiment, providing connection between the RS entries may allow appropriate handling of the uops in the flow.

While controlling the time of dispatch of uops, in one embodiment, the RS 240 may select a first uop for dispatching and then disable the scheduling algorithm used in the RS 240 to select the second uop. In one embodiment, the second uop, which is associated with the first uop by the dependency established by the dependency controlled flow, may be selected using the control generated by the first uop. In one embodiment, the second uop may be assigned a highest priority even if a number of other uops, which may be older, are present in between the first uop and the second uop. Such an approach may ensure that the second uop is dispatched at a specific timing or in a specific clock determined by the controlled flow. In one embodiment, the dependency between the first and the second uop may ensure that the RS 240 picks up the second uop after a specific time elapses after dispatching the first uop.

In one embodiment, the dispatch unit 238 may dispatch the uops to the execution units EU 250. As depicted in FIG. 2(C), while performing a (64×64) bit multiplication, the dispatch unit 238 may dispatch the first uop on a first port P239-1 to the EU 250-1 at time point “T1”. In one embodiment, the source values Src1 and Src2, associated with the single RS entry 224, may be provided to the EU 250-1, respectively, on paths 235-1 and 235-2. In one embodiment, in response to providing the source values associated with the RS entry 224, the dispatch unit 238 may receive a first result on a path 253-1 (port 239-1) from the EU 250-1 and second result on path 253-2 (port P239-2). In one embodiment, the first result may be received on the port P239-1 after the specific duration of time elapses, which may equal 3 cycles in the case of (64×64) bit multiplication. After the specific duration of time (=3 cycles) as determined by the dependency controlled flow elapses, the dispatch unit 238 may dispatch the second uop to the EU 250-1 over the first port P239-1 at a time point “T2”.

In one embodiment, the EU 250-1 may receive source values from the RS 240 and produce two or more results, which may be provided back to the RS 240 over different ports. In one embodiment, the EU 250-1, while performing 64×64 bit multiplication may receive the source values Src1 on path 235-1 and Src2 on path 253-2 and may generate a first result and a second result. The EU 250-1 may provide the first result on path 253-1 (coupled to port P239-1) and the second result on path 253-2 (coupled to port P239-2). In one embodiment, the EU 250-1 may receive the second uop after the specified duration of time (=3 cycles) elapses. In one embodiment, the RS 240 and the EU 250-1 may use the second uop for timing the dispatch of dependent uops and for write-back (WB) arbitration.

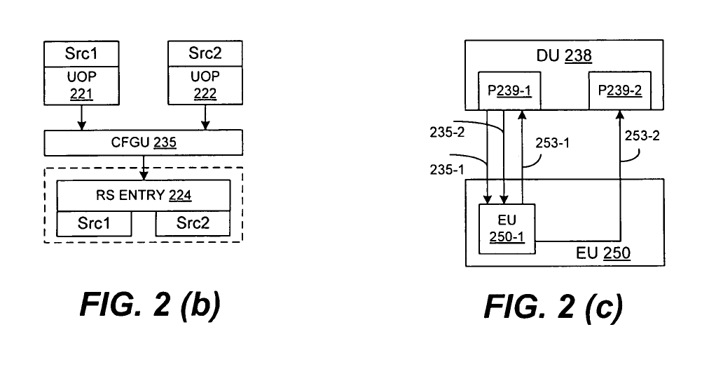

FIG. 3 illustrates an integer multiplication (IMUL) instruction processed by the reservation station RS 240 according to at least one embodiment of the invention.

In block 310, the CFGU 235 may receive the two uops from the IFU 220 in the same allocation window and IFU 220 and the CFGU 235 may ensure that the RS 240 may not dispatch the first uop until the second uop is allocated to the RS 240. While performing a 64*64 bit multiplication, the CFGU 235 may receive IMUL_LOW (“first uop”) and IMUL_HIGH (“second uop”) uops from the IFU 220.

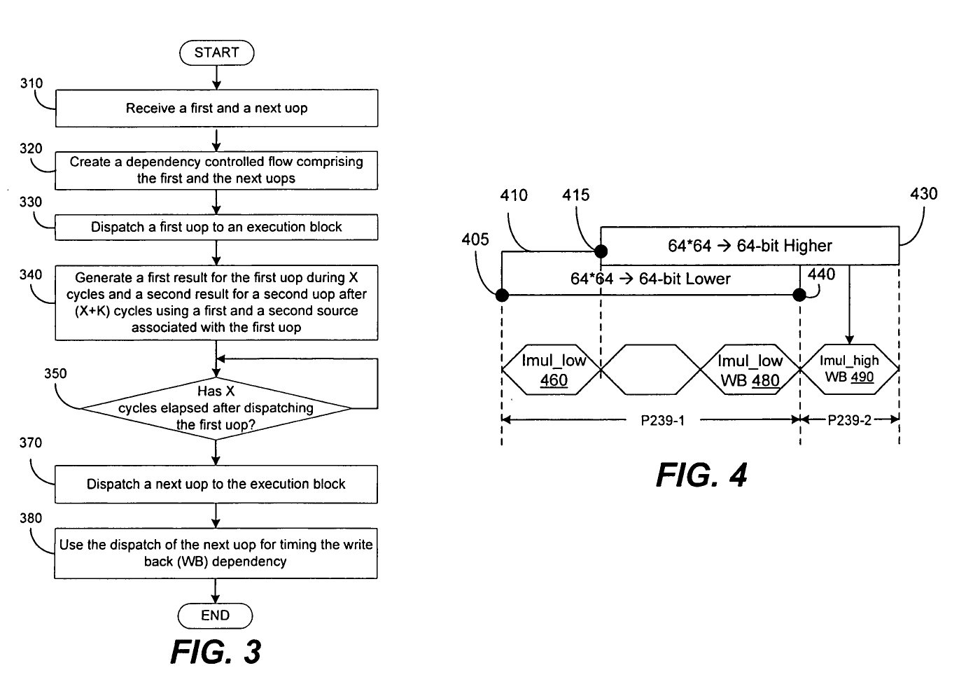

In block 320, the CFGU 235 may create dependency controlled flow comprising micro-operations such as the first and the second uop. In one embodiment, the CFGU 235 may create dependency controlled flow comprising IMUL_LOW and IMUL_HIGH uops. In one embodiment, the CFGU 235 may create dependency between the uops IMUL_LOW represented by 410 and IMUL_HIGH represented by 430 of FIG. 4.

In one embodiment, the CFGU 235 may also provide control along with the IMUL_LOW such that the IMUL_HIGH is dispatched by the RS 240 but, 3 cycles after the IMUL_LOW is dispatched. The three cycle duration may be counted starting from the time point at which the IMUL_LOW uop is dispatched.

For example, the CFGU 235 may convert an original flow represented by the pseudo uops (in lines 301 and 302 below) to generate the dependency controlled flow (depicted in lines 301A and 302B):

Original Flow:

| | |
|---|---|
| 301: RAX := milCtLow (s1, s2); | // this is the first uop and the next |
| | uop depends on it. |
| 302: RDX := mulCtHigh | // the next uop is dispatched 3 |
| (s1, s2, RAX); | cycles after the first uop; RAX is |
| | a implied source. |

Dependency Controlled Flow:

| | |
|---|---|
| 301A: RAX := milCtLow (s1, s2); | // this is the first uop and the next |
| | uop depends on it. |
| 302B: RDX := mulCtHigh | // the next uop is dispatched 3 |
| (s1, s2, RAX); | cycles after the first uop; RAX is |
| | a implied source. |

In one embodiment, the CFGU 235 may transform the uops in lines 301 and 302 above to generate the dependency controlled flow, which is as depicted in lines 308 and 309 below.

| | |
|---|---|
| 308: RAX := mulCtLow (Src1, Src2); | //This is the first uop that is |
| | dispatched to the EU 250-1 on |
| | port 239-1. The EU 250-1 will |
| | produce low result after 3 cycles |
| | into port 239-1 and the second |
| | result into port 239-2 after four |
| | cycles. |
| 309: RDX := mulCtHigh (RAX); | //The next uop depends on the |
| | first uop and is dispatched 3 |
| | cycles after the first uop; The next |
| | uop is used for Write-Back (WB) |
| | arbitration on port 239-2. |

wherein RAX and RDX are register pairs that represent source and destination registers.

In block 330, the dispatch unit 238 may dispatch the first uop (IMUL_LOW) at a time point 405 depicted in FIG. 4. In one embodiment, the RS 240 may determine the time point 405 at which the first uop (IMUL_LOW) may be dispatched. In one embodiment, the dispatch unit 238 may dispatch the first uop to the execution unit 250-1.

In block 340, the execution unit 250-1 may receive the first source value Src1 on path 235-2 and the second source value Src2 on path 235-2 and generate a first result after the ‘X’ cycles and a second result after (X+K) cycles.

In one embodiment, the execution unit 250-1 may generate an intermediate result at time point 415 and the first result may be written back during the third cycle (=X) WB 480 on the path 253-1.

In block 350, the RS 240 may check whether X cycles has elapsed after dispatching the first uop and control passes to block 370 if X cycles has elapsed and to block 350 otherwise.

In response to elapse of X cycles at time point 440, block 370 may be reached. In block 370, the dispatch unit 238 may dispatch the second uop.

In block 380, the RS 240 may use the time point 440 as the reference to initiate the write-back (Imul_high WB 490). However, the second result may be written-back during the fourth cycle Imul-high WB 490 to the port 239-2 using path 253-2.

In other example, the CFGU 235 may also generate a dependency controlled flow while performing a Fused Multiply and Add (FMA) operation. The FMA instruction may be associated with three source values Src1, Src2, and Src3. In one embodiment, the CFGU 235 may receive a first uop and a second uop to perform the FMA operation.

In one embodiment, the CFGU 235 may associate the three source values Src1, Src2, and Src3 with the two uops. In one embodiment, the CFGU 235 may associate Src1 and Src2 with the first uop and Src3 with the second uop such that the second uop is used to appropriately sequence the third source value Src3. Also, the CFGU 235 may mark the second uop such that the RS 240 may schedule the third source value Src3 such that the third source value Src3 may be received by the first uop at a required time. Alternatively, the RS 240 may dispatch the third source value Src3 along with the first uop and discard the second uop.

In one embodiment, the CFGU 235 may convert the original pseudo uops (in lines 311 and 312 below) to generate the dependency controlled flow in lines 311-A and 312-A):

Original Order:

| | |
|---|---|
| 311: dest = FMA_uop1 (s1, s2) | // Port P239-1, 5 cycle FMA - |
| | starts with two source FMUL; |
| | followed by ADD. |
| 312: sink = FMA_uop2 (sink, s3) | // Port P239-5, 1 cycle uop that |
| | provides the third source value |
| | Src3 |

Dependency Controlled Flow:

| | |
|---|---|
| 311A: dest = FMA_uop1 (s1, s2) | // Port P239-1, 5 cycle FMA - |
| | starts with two source FMUL; |
| | followed by ADD. |
| 312A: sink = FMA_uop2 (dest, s3) | // Port P239-5, 1 cycle uop that |
| | provides the third source value |
| | Src3 |

In one embodiment, the CFGU 235 may transform the uops in lines 311 and 312 above to generate the reduced dependency controlled flow, which is depicted below in line 318 such that the second uop is removed.

| | |
|---|---|
| 318: dest = FMA_uop1 | //Port P239-1, 5 cycle FMA - |
| (Src1, Src2, Src3); | starts with two source FMUL; |
| | followed by ADD that receives |
| | the third source value Src3. |

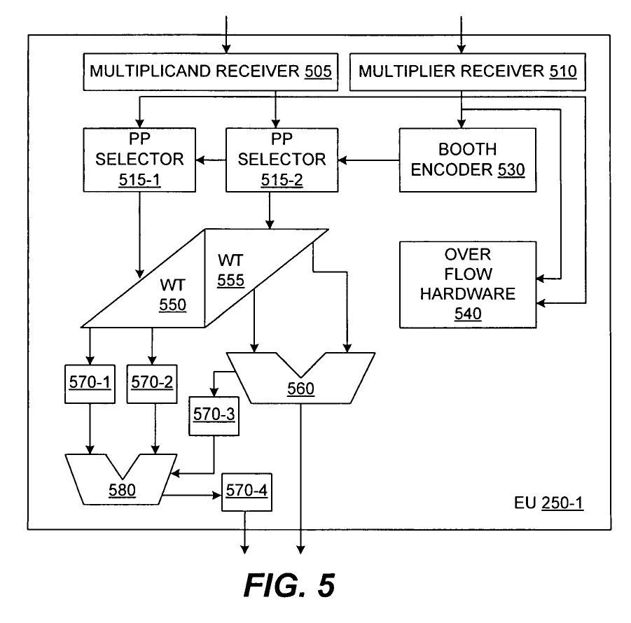

FIG. 5 illustrates an execution unit (EU) 250-1, which handles uops of the dependency controlled according to at least one embodiment of the invention In one embodiment, the operation of a 64×64 multiplication may generate 128-bit value, which may be produced in two portions of 64 bits each that correspond to IMUL_Low uop and the IMUL_High uop. In one embodiment, the EU 250-1 may comprise a multiplicand receiver 505, a multiplier receiver 510, partial products (PP) selector 515-1 and 515-2, a booth encoder 530, a first Wallace tree WT 555, a second Wallace tree WT 550, a final low adder 560, temporary storage elements 570-1, 570-2, and 570-3, and 570-4, and final high adder 580.

In one embodiment, the multiplier receiver 510 may receive the first source value and provide the source value to the booth encoder 530. The booth encoder 530 may generate the partial products result, which may represent the lower 64 bits of the result. The partial products may be provided to the PP selector 515-2.

In one embodiment, the PP selector 515-2, which receives a second source value from the multiplicand receiver 505 may provide the partial product value generated by the booth encoder 530 and the second source value to the Wallace tree WT 555. In one embodiment, the PP selector 515-1 may also provide the second source value and the partial products to the Wallace tree WT 550.

In one embodiment, the Wallace tree WT 555 may produce an intermediate result from the partial products and the second source value and the intermediate result may be provided to the final low adder 560, which may compute the lower 64-bits result. In one embodiment, the WT 555 may also provide the intermediate result to the WT 550.

In one embodiment, while generating the upper 64 bit result, the Wallace tree WT 550 may receive the intermediate result generated by a combination of the booth encoder 530 and WT 555 without a need a for external data communication. In one embodiment, the WT 550 may generate a upper result, which may be provided to the final high adder 580 through temporary storage elements 570-1 and 570-2. In one embodiment, to generate the upper 64 bits result, the same logic circuitry such as the booth encoder 530 and the WT 555 may be required to prepare the inputs to the upper portion of the Wallace tree WT 550. However, as the CFGU 235 provides a combined uop generated from the first and the second uop, a logic comprising a booth encoder and a Wallace tree, which is a duplicate of the booth encoder 530 and the WT 555 that may be required to generate the upper 64 bits result may be avoided. Such an approach may save the real estate of the integrated circuit and also the power consumed by such a logic circuitry.

In one embodiment, the final high adder 580 may generate upper 64 bits in response to receiving data from the WT 550 through temporary storage elements 570-1 and 570-2 and the final low adder 560 through a temporary storage element 570-3. In one embodiment, the upper 64 bit result may be provided during a specific cycle after the final low adder 560 provides the lower 64 bit result.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
receiving a plurality of micro-operations representing an instruction;
generating a dependency controlled flow using the plurality of micro-operations in a reservation station of an out-of-order execution block, wherein the dependency between a first micro-operation and a second micro-operation of the plurality of micro-operations established by the dependency controlled flow ensures that the second micro-operation is dispatched after a specific delay after dispatching the first micro-operation; and
generating a plurality of results in an execution block using a plurality of source values received from the reservation station, wherein the plurality of results are provided over a plurality of ports of the reservation station.

2. The method of claim 1, wherein the dependency controlled flow is to map a combination of the first micro-operation and the second micro-operation of the plurality of micro-operations into a single reservation station entry, wherein a first set of source values associated with the first micro-operation and a second set of source values associated with the second micro-operation is associated with the single reservation station entry.

3. The method of claim 1, wherein the dependency controlled flow is to assert a line after dispatching a first reservation station entry, wherein the asserted line is to ensure dispatch of the second reservation station entry that is ready, wherein the second reservation station entry is dispatched after a specific delay after the first reservation station entry is dispatched.

4. The method of claim 3, wherein the dependency controlled flow comprising the first micro-operation and the second micro-operation is generated based on the dependency imposed between the first micro-operation and the second micro-operation.

5. The method of claim 2, wherein the single reservation station entry is generated by encoding the first and the second micro-operations.

6. The method of claim 1, wherein the plurality of results generated by the execution block comprises a first result provided on a first port of the reservation station and a second result provided on a second port of the reservation station.

7. The method of claim 6, wherein the second micro-operation is dispatched after K clock cycles elapses after dispatching the first micro-operation,
wherein the first micro-operation is completed within K clock cycles,
wherein the second micro-operation is not associated with the plurality of source values,
wherein the second micro-operation establishes the dependency of a second result generated by the execution block using the first micro-operation.

8. The method of claim 1, wherein the instruction represents a 64×64 bit multiplication instruction that generates a 128 bit result, wherein the 128 bit result comprises a lower 64 bit result and a upper 64 bit result, wherein ‘x’ represents a multiplication operation and the plurality of micro-operations comprise the first micro-operation and the second micro-operation.

9. The method of claim 8, wherein the first micro-operation represents a lower 64 bit multiplication operation of the 64×64 bit multiplication instruction and the second micro-operation represents a higher 64 bit multiplication operation of the 64×64 bit multiplication instruction.

10. The method of claim 1, wherein the instruction represents a fused Multiply and Add instruction comprising a third micro-operation and a fourth micro-operation, wherein the third micro-operation is dispatched with a third and a fourth source value and the fourth micro-operation is dispatched to sequence the fifth source value.

11. The method of claim 10, wherein the third micro-operation is dispatched with a third, a fourth and a fifth source value after discarding the fourth micro-operation.

12. An apparatus comprising:
an in-order front end unit,
an in-order retire unit, and
an out-of-order execution unit interposed between the in-order front end unit and the in-order retire unit, wherein the out-of-order execution unit further comprises,
a reservation station is to generate a dependency controlled flow using the plurality of micro-operations, wherein the dependency between a first micro-operation and the second micro-operation of the plurality of micro-operations established by the dependency controlled flow ensures that a second micro-operation is dispatched after a specific delay after dispatching the first micro-operation; and
an execution unit coupled to the reservation station, wherein the execution unit is to generate a plurality of results using a plurality of source values received from the reservation station, wherein the plurality of results are provided over a plurality of ports of the reservation station.

13. The apparatus of claim 12, wherein the reservation station further comprises a controlled flow generation unit, wherein the controlled flow generation unit is to map a combination of the first micro-operation and the second micro-operation of the plurality of micro-operations into a single reservation station entry, wherein a first set of source values associated with the first micro-operation and a second set of source values associated with the second micro-operation is associated with the single reservation station entry.

14. The apparatus of claim 12, wherein the dependency controlled flow is to assert a line after dispatching a first reservation station entry, wherein the asserted line is to ensure dispatch of the second reservation station entry that is ready, wherein the second reservation station entry is dispatched after a specific delay after the first reservation station entry is dispatched.

15. The apparatus of claim 14, wherein the controlled flow generation unit is to generate the dependency controlled flow comprising the first micro-operation and the second micro-operation based on a dependency imposed between the first and the second micro-operations.

16. The apparatus of claim 12, wherein the controlled flow generation unit is to generate the single reservation station entry by encoding the first micro-operation and the second micro-operation.

17. The apparatus of claim 12, wherein the reservation station further comprises a dispatch unit coupled to the controlled flow generation unit, wherein the dispatch unit is to dispatch the second micro-operation after K clock cycles elapses after dispatching the first micro-operation,
wherein the first micro-operation is completed within K clock cycles,
wherein the second micro-operation is not associated with the plurality of source values,
wherein the second micro-operation establishes the dependency of a second result generated by the execution block using the first micro-operation.

18. The apparatus of claim 12, wherein the execution unit is to generate the plurality of results comprising a first result of the plurality of results provided on a first port of the plurality of ports of the reservation station and a second result of the plurality of results provided on a second port the plurality of ports of the reservation station.

19. The apparatus of claim 18, wherein the execution unit further comprises:
a booth encoder, wherein the booth encoder is to receive a first source value,
a first wallace tree multiplier coupled to the booth encoder, wherein the first wallace tree multiplier is to generate an intermediate value in response to receiving the partial products from the booth encoder and the second source value,
a second wallace multiplier coupled to the first wallace multiplier, wherein the second Wallace multiplier is to generate a result using the intermediate value and the second source value,
wherein the execution unit is to provide a first result on a first port of the reservation station and a second result on a second port of the reservation station.

20. The apparatus of claim 12, wherein the controlled flow generation unit is to generate the dependency controlled flow comprising the first and the second micro-operations for a 64×64 bit multiplication instruction that generates a 128 bit result, wherein the 128 bit result comprises a lower 64 bit result and a upper 64 bit result, wherein ‘x’ represents a multiplication operation and the plurality of micro-operations comprise the first and the second micro-operation.

21. The apparatus claim 19, wherein the first micro-operation represents a lower 64 bit multiplication operation of a 64×64 bit multiplication instruction and the second micro-operation represents a higher 64 bit multiplication operation of a 64×64 bit multiplication instruction.

22. The apparatus of claim 12, wherein the controlled flow generation unit is to generate the dependency controlled flow for a fused Multiply and Add instruction comprising a third micro-operation and a fourth micro-operation, wherein the third micro-operation is dispatched with a third and a fourth source value and the fourth micro-operation is dispatched to sequence the fifth source value.

23. The apparatus of claim 22, wherein the third micro-operation is dispatched with a third, a fourth and a fifth source value after discarding the fourth micro-operation.
